(19) United States
(12) Patent Application Publication
(10) Pub. No.: US 2022/0055921 A1
(43) Pub. Date: Feb. 24, 2022

(54) DEVICE TO REDUCE MICROPLASTIC PARTICLES AND FIBERS IN WATER

(71) Applicant: Fionn Miguel Eckardt FERREIRA, Groningen (NL)

(72) Inventor: Fionn Miguel Eckardt FERREIRA, Groningen (NL)

(21) Appl. No.: 17/408,577

(22) Filed: Aug. 23, 2021

Related U.S. Application Data
(60) Provisional application No. 63/069,098, filed on Aug. 23, 2020.

(51) Int. Cl. C02F 1/26; B01D 11/04

(52) U.S. Cl. CPC C02F 1/26; C02F 2101/38; B01D 11/0492

(57) ABSTRACT

A device for removing microplastics from water. The device has a tank containing water and an oil layer floating on the water. The tank has an inlet for making a mixture of microplastics and water and an outlet for draining clean water. The device has a provision for causing the mixture of microplastics in water to flow through the oil layer wherein microplastics are trapped and clean water flows through the oil layer.

### CROSS-REFERENCE TO RELATED APPLICATION

This is a non-provisional application claiming priority to U.S. Ser. No. 63/069,098 filed Aug. 23, 2020, which is incorporated herein in its entirety.

### BACKGROUND OF THE INVENTION

### Technical Field

This invention relates to the removal/separation of microplastics from water.

### Discussion

Microplastic particles are plastic particles of sizes less than 5 mm in diameter including nanoplastics less than 5 nm in diameter. They can come from both primary and secondary sources i.e. can be made as microplastics such as those added as abrasives to facial scrubs, toothpastes and other cosmetics or result from the breakdown of larger macroplastics. They have been shown to cause harm to animals and humans if consumed regularly at the current average of 5 g of plastic consumption per week (and can bio-accumulate in organisms meaning that they can travel through the food chain and end up on our plates). Microplastics have been identified as a severe environmental and human threat. It is therefore essential to implement technologies to remove these from water before they enter the environment i.e. rivers, waterways of the sea. To do this, they must be removed at source. This is mainly domestic and industrial wastewaters, as well as the run-off water from roads containing rubber tyre-dust. Due to the small size, they are very difficult to remove from water and current methods rely heavily on sieving and filtration methodology (See M. War U.S. Pat. No. 8,944,253B2). Filtration and sieving cannot be carried out on wastewater since it contains many other particles and suspended solids that could clog the filters. Microplastic particles have also been found in drinking water even after treatment. Hence there is also a need for technology to remove microplastics from domestic water systems or as a part of municipal water treatment.

### SUMMARY OF THE INVENTION

A device which removes microplastics from water using a liquid separation based on the similar polarity of microplastic particles and plant based or other oil. It may be used in different scales depending on the application; it may be implemented in domestic wastewater or commercial waters. For domestic wastewater, the largest microplastic source has been identified as washing machines, showers and sinks. Therefore, the device may be implemented in the cleaning of household greywater at treatment facilities or directly by the consumer in the household. It may also be implemented to clean river or even ocean water-water can be pumped into the facility, passed through the device and released back into the river downstream of the plant cleaning river water quality or back into the ocean.

A device for removing microplastics from water has a tank containing of water and oil layer floating on the water. The tank has an inlet for admitting a mixture of microplastics and water to allow the mixture to flow into the tank. The tank has an outlet for draining the water. The outlet has a level control for controlling water level in the tank. The tank has a provision for causing the microplastic and water mixture to flow through the oil layer.

The inlet may be above the oil layer. The device may have at least one generally vertically baffle for dividing the tank into horizontally adjacent chambers. The outlet may be toward a bottom of the tank.

The outlet may be at a portion of the tank which is furthermost from the inlet.

The level control may be a valve or a weir.

### BRIEF DESCRIPTION OF THE DRAWINGS

FIG. 1 is a cross-sectional elevation of an embodiment of the device according to the present invention taken on line 1-1 of FIG. 2;

FIG. 2 is a perspective view from one side of the device of FIG. 1;

FIG. 3 is a perspective view from the rear and toward one side of the device of FIG. 1;

FIG. 4 is a cross-sectional elevation of an alternate embodiment of the device according to the present invention;

FIG. 5 is a cross-sectional elevation of another embodiment of the device according to the present invention;

FIG. 6 is a view corresponding to FIG. 5 but showing lowering of a gate for oil removal;

FIG. 7 is a cross-sectional elevation of yet another embodiment of the device according to the present invention; and,

FIG. 8 is a cross-sectional elevation of yet another embodiment of the device according to the present invention.

### DESCRIPTION OF PREFERRED EMBODIMENTS

A device to remove microplastics from water using a polarity-phase based separation process. The general theory of the method is that water is passed through a layer of non-polar plant-based oil.

Although plant-based oil is referred to in the description as it has shown good results in testing, it will be appreciated that other oils or non-polar liquids might be utilized.

Different types of plastic have different densities. Some will float on water whereas others may not. Accordingly, different densities of non-polar fluid may be selected depending on the type of plastic being targeted. Plant-based oils may be desirable from an environmental standpoint.

A device may be placed inline in water streams of both washing machine discharge (capturing nylon and polyester fibers released during the washing of clothes and identified the second largest microplastic source in the US after tire dust). It may also be used on a larger scale in wastewater treatment centers to capture microplastics as well as in the treatment of waters from plants where microplastics are found in water, e.g. recycling plants, textile, auto and paint industries. Microplastics have also been found in drinking water even after treatment. Therefore the device may also be used in water treatment plants for drinking water including municipalities or as a retrofit device for domestic mounting. Polar materials such as organic matter suspended in the water can pass through without blockage. The device requires less time and has extraction rates above 80% at a water-oil contact of merely 1-2 seconds, however more contact with oil will yield higher extraction. Therefore, two or more devices may be placed in series a for more thorough extraction.

Periodically, when the oil becomes saturated, the consumer or device user can replace the oil, using store bought frying oil. It is also possible to use waste cooking oil (after cooking) provided it has been screened for suspended particles. The residue from the device can be sent to a separation facility where the oil can be separated from the plastic using a centrifuge, filtration or other methods. The oil may be re-used for further extractions following this.

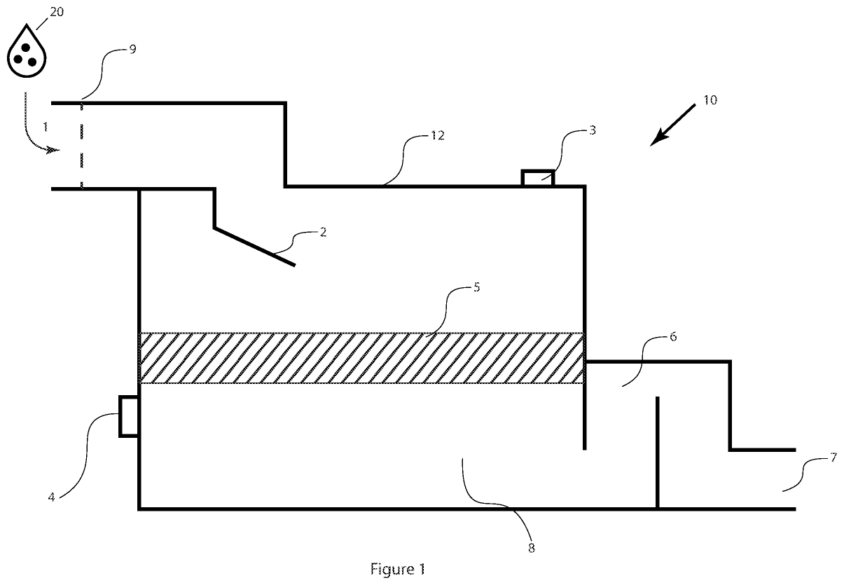

FIG. 1 shows a cross-sectional elevation of a first embodiment of a device, 10 according to the present invention. The device 10 has a tank 12 containing water 8 with an oil layer 5 floating thereon. Contaminated water 20 is fed into the tank 12 through an inlet 1 via a pipe. The contaminated water 20 hits a plate 2 which is angled so the water is distributed over the oil 5 after it flows over this angled plate, increasing plastic contact with the oil and the uptake of the microplastic particles from the contaminated water 20. The oil layer 5 is shown as a volume of oil inside the tank 12 of the device 10. The oil layer 5 floats on the water 8 preventing it from being lost in the device 10. The water 8 is kept from flowing away by a trap 16 having a weir 6 which keeps the liquids in the device at the desired level. The trap 16 also prevents oil which may have mixed with water from leaving the device and traps it. Ports 3 and 4 allow for the addition and removal of oil mixture respectively. The addition and removal of oil may be done manually or with an automated system using a series of pumps. Microplastics are captured in the oil layer 5 and the cleaned water can exit the device through an outlet 7. Water that enters the system may be passed through a screen mesh 9, for example of size 5 mm or greater to remove very large debris which may clog the device. If the device 10 is implemented in an industrial wastewater treatment center, the 5 mm screen 8 can be omitted and the device simply placed after the initial screening of wastewater. If this were implemented in a washing machine, similarly no screen would be required. Contaminated water 20 which required screening is that which contains large debris such as drainage water from roads or river water.

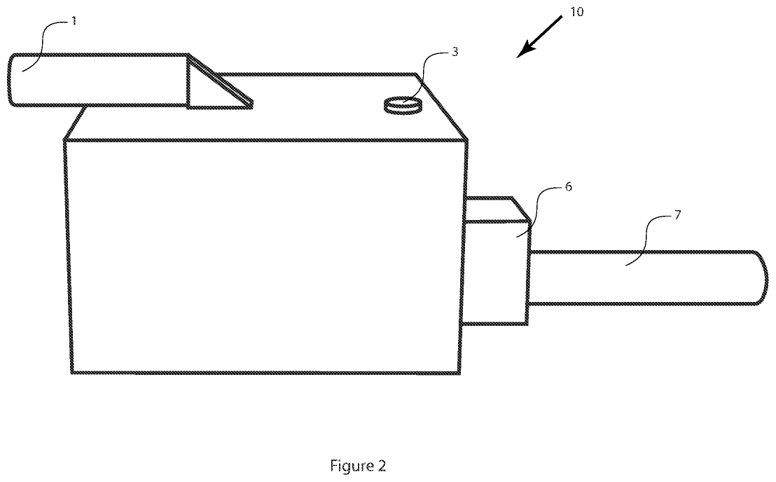

FIG. 2 illustrates an outside view of the device 10. The device size and appearance may vary depending on the application scale and surroundings. Affixing hardware may be added to allow for convenient fixing of the device as a retrofit for washing machines, or shower/sink wastewater outlets with a volume of approximately 1 L of water. For larger industrial application, a large tank may be required containing many cubic meters of water.

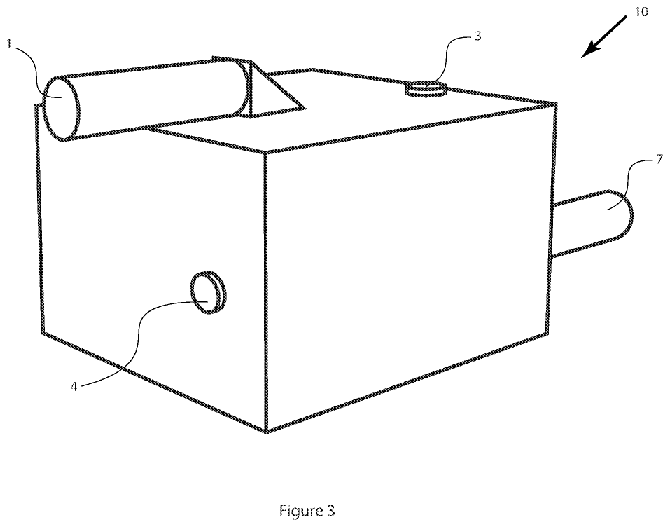

FIG. 3 presents a different view of the outside of the device 10. The device 10 should be mounted in the orientation shown since the water and oil levels must be in the stipulated position.

The device 10 uses polarity to remove micro and nano plastic debris from contaminated water 20. Contaminated water 20 enters the device 10 and is poured through the oil layer 5. When coming into contact with the non-polar vegetable based oil layer 5 the plastics migrate from the contaminated water 20 to the oil layer 5 and become lodged in the oil layer 5. This method works for both freshwater and saltwater streams. The device 10 may be half filled with water to allow for a constant oil-water interface and therefore the trap 16 is put in place to maintain the required liquid level in the container. Cleaned water can flow out over the weir 6 in the trap 16. The trap 16 may be opened for cleaning in case of clogging as well as the tank 10 and the mesh screen 9. In an industrial application, the device may not need to be covered and thus would be easy to observe and monitor.

The oil used must be largely non-polar. For this purpose, plant-based vegetable oils may be used as well as waste vegetable oils after cooking. However, as mentioned above, other oils or fatty acid compounds such as vegetable, mineral and animal oils or perhaps even waxes may be suitable depending on the nature of the non-polar particulates being removed. Following the extraction the oil and plastic can be separated and the oil re-used therefore minimizing the acquisition of new oil in the running of the device.

After a predetermined period of use, the oil mixture must be replaced since it becomes saturated with captured microplastic debris. The old oil mixture can be removed via port 4 and new oil can be added via port 3. A sensor may be installed in the system to test the saturation of the oil layer 5 and indicate when it needs to be replaced. Depending on the application, an automated system may be installed for this which can remove the oil from the device, clean it suing the series of filters or a centrifuge and return the oil to the system. A system may also be incorporated which adds oil if the level is low due to oil losses.

Measurements have not been included in the diagrams since the device 10 can be scaled appropriately depending on the size of the application. By way of example, an oil layer 5 of thickness 20 mm or greater has yielded extraction rates higher than 87% in testing. A thicker layer will provide more thorough extraction.

The removed plastic can be separated from the oil using density separation in a slow centrifuge, the remaining oil can be re-used in the device. The separation may also be conducted using a micron sieve screen. This works with the oil since it does not contain other materials than the plastics. This means that continuous cleaning of the oil in a loop system could be incorporated for larger applications.

The application of this in a domestic setting may contain a larger volume of oil to reduce the frequency the oil needs to be replaced. A self-cleaning version may also be made for the domestic application requiring the operator to remove the microplastic particles and place them in regular trash for safe disposal. A microporous membrane “sock” may be placed inline in the oil cleaning lop removing suspended plastic particles. Once this is full, it can be easily disposed of.

Another application for this device is to clean drinking water from microplastic debris.

Daisy chaining a plurality of devices 10, i.e. linking them together so water gets treated more than once, can have increased overall microplastic extraction rates. Any oil in the wastewater, e.g. cooking wastewater will also remain in the oil phase thus adding another possible application to the cycle.

Heavily surfactant loaded waters can cause problems since an emulsion of oil is formed and therefore must be avoided. The selection of the oil type and quantity used may eliminate or minimize this problem.

The device may also be implemented in water streams in ships and boats such as those to cool the engine. Like this microplastics would be removed from the water as the boats operate across oceans and inland waterways. In some cases, ferrofluid may be used instead of the oil layer. The ferro-fluid would consist of a mixture of oil and magnetite particles in suspension. This would allow the picking up of the mixture using electro-magnets or other magnets for the separation.

Preferably, turbulence should be avoided as the contaminated water 20 is poured onto the oil layer. One manner of doing so is using a diffuser such as the angled plate 2. Other approaches may be used such as for example a “shower head” type of arrangement.

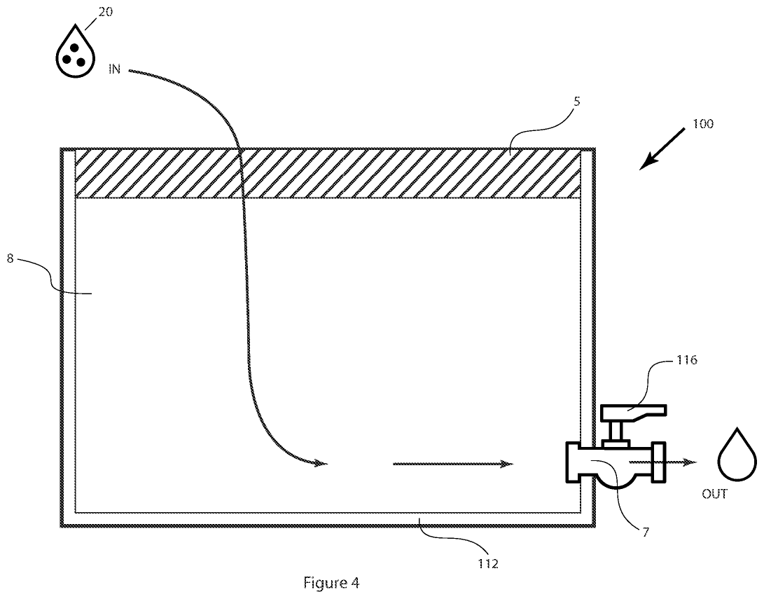

FIG. 4 shows an alternate embodiment 100 of an device according to the present invention which uses a valve 116 to control level of the water 8 in a tank 110 rather than the trap 16 of the FIGS. 1 to 3 embodiment. Similar features are identified with similar reference numerals throughout the drawings.

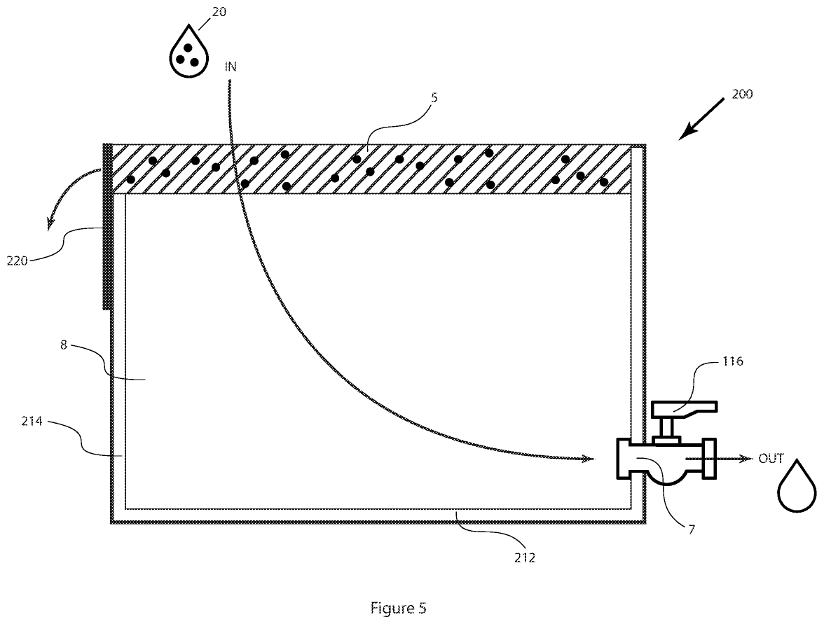

FIG. 5 illustrates an device 200, similar to the device 100 in FIG. 4 but in which a side 214 of a tank 212 is shorter for at least a portion of its breadth than the remaining sides. The shortfall is covered by a gate 220 to keep the oil layer 5 in place.

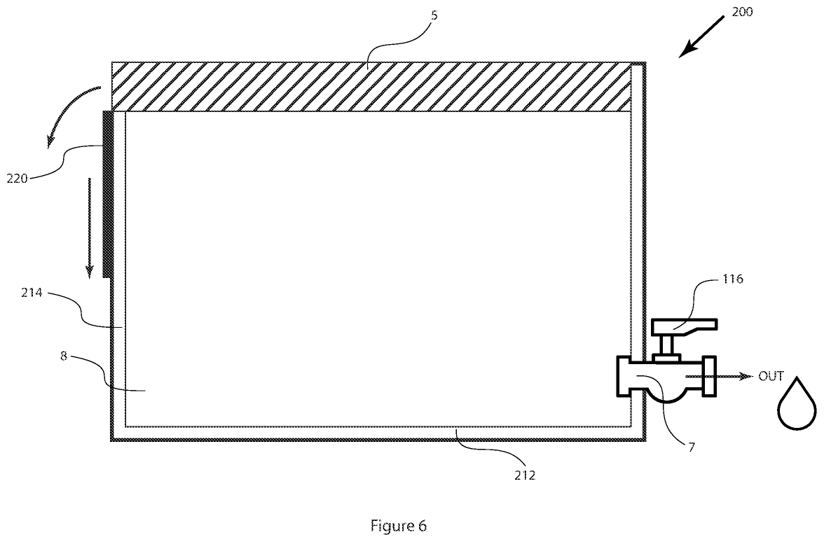

FIG. 6 shows the tank 212 with the gate 220 lowered for draining of the oil layer 5.

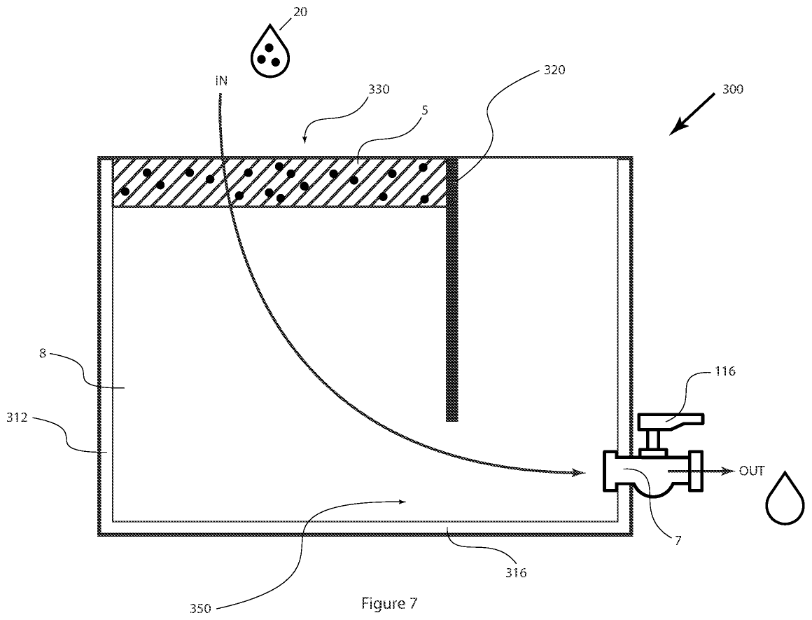

FIG. 7 shows an embodiment in which an device 300 similar to the device 100 of FIG. 4 is provided. The device 300 has a generally vertically extending baffle 328 which extends between opposite sidewalls of a tank 312 of the device 300 to divide it into horizontally adjacent first and last chambers 330 and 340 respectively.

The oil layer 5 covers the water 8 in the first chamber 330.

The baffle does not extend fully to a bottom 316 of the tank 312 thereby defining a passage 350 for allowing water 8 to flow therethrough into the adjacent last chamber 340. This design laterally separates the outlet 7 from the oil layer 5. Any oil passing under the baffle 320 may separate from the water 8 and float to the top of the last chamber 340.

It will be appreciated that more than one baffle may be used thereby creating more than two chambers to further remove any residual oil. This might be useful if the inflow of the contaminated water 20 is turbulent and forces some of the oil layer 5 into the water 8.

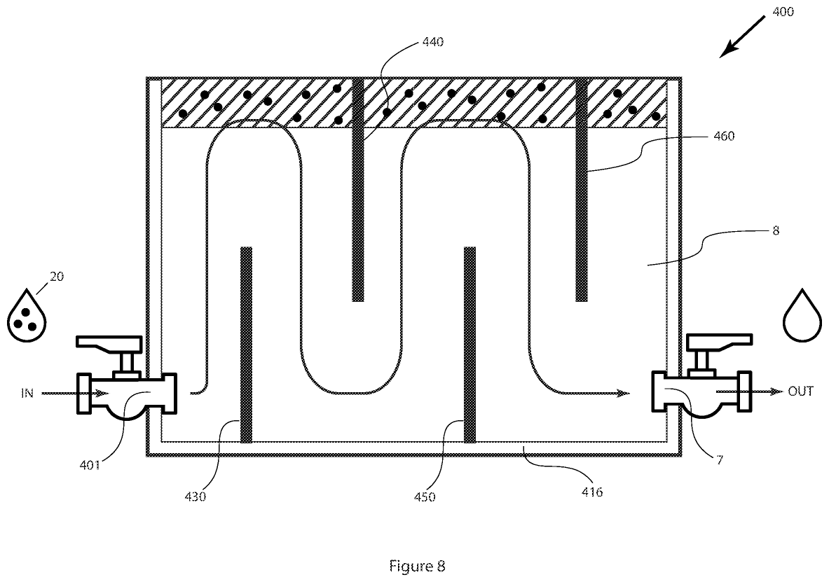

FIG. 8 shows an embodiment in which an device 400 has the contaminated water 20 introduced into an inlet 401 toward a bottom 416 of tank 412 and directed by a series of baffle 430, 440, 450 and 460 to flow through the oil layer 5.

The above description is intended in an illustrative rather than a restrictive sense. Variations may be apparent to those skilled in the art while remaining within the scope of the invention as defined by the claims set out below.

What is claimed is:

1. An device for removing microplastics from water, said device comprising:
a tank containing water and an oil layer floating on said water;
said tank having an inlet above said oil layer for admitting a mixture of microplastics in water to allow said mixture to flow onto said oil layer;
said outlet having a level control for controlling water level in said tank.

2. The device of claim 1 further having at least one generally vertically extending baffle for dividing said tank into horizontally adjacent chambers with said oil layer and said inlet being in a first of said chambers;
each said at least one baffle defining a passage toward a bottom of said tank for allowing water to flow therethrough into an adjacent of said chambers.

3. The device of claim 1 wherein the outlet is toward a bottom of said tank.

4. The device of claim 2 wherein the outlet is through a last chamber furthermost from said first chamber.

5. The device of claim 4 wherein the outlet is toward a bottom of said tank.

6. The device of claim 1 wherein the level control is a valve.

7. The outlet of claim 1 wherein the level control is a weir.

8. An device for removing microplastics from water, said device comprising:
a tank containing water and an oil layer floating on said water;
said tank having an inlet below said oil layer for making a mixture of microplastics in water;
said tank having an outlet for draining said water;
said outlet having a level control for controlling water level in said tank;
said tank further having a plurality of baffles extending thereacross for directing said microplastic and water mixture through tank in a serpentine path and into said oil layer.
